(19) United States
(12) Patent Application Publication
(10) Pub. No.: US 2023/0279994 A1
(43) Pub. Date: Sep. 7, 2023

(54) Container Systems and Methods for Using the Same

(71) Applicant: ExxonMobil Technology and Engineering Company, Spring, TX (US)

(72) Inventor: Ananda K. NAGAVARAPU, Houston, TX (US)

(21) Appl. No.: 18/006,614

(22) PCT Filed: Jun. 10, 2021
(86) PCT No.: PCT/US2021/070688

§ 371 Date: Jan. 24, 2023

Related U.S. Application Data
(60) Provisional application No. 63/056,779, filed on Jul. 27, 2020.

(51) Int. Cl. F17C 3/10

(52) U.S. Cl. CPC F17C 3/10; F17C 2201/035; F17C 2201/054; F17C 2203/0333; F17C 2203/0387; F17C 2203/0391; F17C 2203/0604; F17C 2203/0607; F17C 2203/0643; F17C 2221/011; F17C 2221/014; F17C 2221/016; F17C 2221/033; F17C 2223/0161; F17C 2223/033; F17C 2227/0135; F17C 2260/033; F17C 2265/031

(57) ABSTRACT

Container systems for the transportation and/or storage of Liquefied Natural Gas (LNG) are provided. The container systems include: a) an outer shell; b) an inner pressurized container, wherein the inner pressurized container comprises a first chamber having a first vent and at least one other chamber having a second vent; c) at least one heat exchange zone in thermal communication between the first chamber and the at least one other chamber; and d) an interstitial space between the outer shell and the inner pressurized container including at least a partial vacuum. Methods for transporting and/or storing LNG using the aforementioned container systems are also provided.

### CROSS REFERENCE TO RELATED APPLICATION

This application claims the priority benefit of U.S. Provisional Pat. Application No. 63/056779 filed Jul. 27, 2020, entitled CONTAINER SYSTEMS AND METHODS FOR USING THE SAME.

### FIELD OF THE INVENTION

The invention relates to container systems and related methods for the transportation and/or storage of liquefied natural gas (LNG).

### BACKGROUND OF THE INVENTION

Liquefied natural gas (LNG) is natural gas cooled down to its boiling point temperature of approximately -163° C. at atmospheric pressure to reach cryogenic liquid conditions. LNG is produced to enable the efficient storage and transport of natural gas. LNG is stored and transported in cryogenic containers. The LNG can be converted to natural gas by a process called regasification (vapourisation) and is typically used for fuel for domestic or industrial use and power generation.

A cryogenic container is a thermally-insulated container for storing or transporting liquefied gases at cryogenic temperatures. Depending upon the design of the container, the operating pressure can generally range from atmospheric to above 400 psia. Typically a cryogenic container includes an inner vessel for containing the cryogenic fluid, e.g. LNG, and an outer vessel for insulating the cryogenic fluid from the environment. The gap between the two vessels is at least partially evacuated to form a vacuum, which provides an insulating barrier and reduces the heat leakage into the cryogenic container from the ambient environment. To further reduce the heat leakage, heat reflective paints or insulation materials are also used. In certain cases, a superconductive layer comprising a material that is superconducting at the temperature of the cryogenic fluid is also used. This superconductive layer forms a magnetic field around the cryogenic container that repels electromagnetic energy, including thermal energy from the environment, keeping the cryogenic fluid at low temperatures. Other cryogenic container systems are also available for the transport of LNG. More recently, cryogenic ISO containers are being used to for storage of cryogenic fluids such as LNG. These containers are usually of standardized sizes ranging from cylinders of 8 feet in diameter and 10 to 40 feet in length.

Natural gas, for export as LNG, is sourced from an offshore or onshore natural gas field, a coal mine, a marine source, biogas facility or a diversion of flare-gas. The gas is delivered to a liquefaction plant (LNG plant) located on site or at the export port.

Background references include U.S. Pat. Nos, 6,212,891, 7,837,055; EP 2, 228 294 A; and WO 2000/57102.

ISO containers are starting to become a popular choice for the transport of LNG (virtual pipelines). Here, LNG is filled into a vacuum insulated ISO container and distributed by conventional transport mechanisms, such as, road or rail. These containers do not have any refrigeration systems connected to them, and the boiling methane results in an increase in the contained fluid pressure. Typical rating of these systems are around 350 psig, which results in thicker metal and increased cost. Furthermore, despite the higher pressure rating, there is a limit to how much LNG can be filled in these containers, as a function of anticipated shelf-life. A typical ISO container is expected to have a boil-off rate in the order of ~0.17% of the LNG per day. At this boil-off rate, the amount of LNG that can be stored and/or transported as a function of shelf-life is limited. Therefore, there exists a need for improved containers and related methods that can store and/or transport LNG.

### SUMMARY OF THE INVENTION

In a class of embodiments, the invention provides for a container system for the transportation and/or storage of Liquefied Natural Gas (LNG), the container system comprising: a) an outer shell; b) an inner pressurized container, wherein the inner pressurized container comprises a first chamber having a first vent and at least one other chamber having a second vent; c) at least one heat exchange zone in thermal communication between the first chamber and the at least one other chamber; and d) an interstitial space between the outer shell and the inner pressurized container comprising at least a partial vacuum.

In another class of embodiments, the invention provides for a method for transporting and/or storing LNG comprising: a) filling the container system as described above with a primary fluid and sacrificial cryogenic fluid; b) sealing the container system; c) venting off a sacrificial gas to maintain a desired pressure of the inner pressurized container; and d) transporting and/or storing the LNG for at least 5 days without refilling the container system; wherein the inner pressurized container has a boil-off rate of < 0.20% of LNG per day.

Other embodiments of the invention are described and claimed herein and are apparent by the following disclosure.

### BRIEF DESCRIPTION OF THE DRAWINGS

FIG. 1 is a graphical representation of LNG evaporating from a container in cargo weight (Kg) over a thirty day period.

FIG. 2A is a schematic representation of a container system in accordance with one class of embodiments of the invention.

FIG. 2B is a schematic representation of a container system in accordance with one class of embodiments of the invention, with a heat exchange option.

FIG. 2C is a schematic representation of a container system in accordance with one class of embodiments of the invention, with another heat exchange option.

### DETAILED DESCRIPTION OF THE INVENTION

Various terms are defined in the following Specification. A Glossary of terms is provided herein, immediately preceding the claims.

Before the present compounds, components, compositions, devices, softwares, hardwares, equipments, configurations, schematics, systems, and/or methods are disclosed and described, it is to be understood that unless otherwise indicated this invention is not limited to specific compounds, components, compositions, devices, softwares, hardwares, equipments, configurations, schematics, systems, methods, or the like, as such may vary, unless otherwise specified. It is also to be understood that the terminology used herein is for the purpose of describing particular embodiments only and is not intended to be limiting.

It must also be noted that, as used in the specification and the appended claims, the singular forms “a,” “an” and “the” include plural referents unless otherwise specified. Containers/Container Systems

In a class of embodiments, the invention provides for a container system for the transportation and/or storage of Liquefied Natural Gas (LNG), the container system comprising:
a) an outer shell;
b) an inner pressurized container, wherein the inner pressurized container comprises a first chamber having a first vent and at least one other chamber having a second vent;
c) at least one heat exchange zone in thermal communication between the first chamber and the at least one other chamber; and
d) an interstitial space between the outer shell and the inner pressurized container comprising at least a partial vacuum.

In these embodiments, a “sacrificial” cryogenic liquid is used to preferentially evaporate, while maintaining the LNG at low pressure and in liquid state. Examples of such sacrificial cryogenic liquids are liquid oxygen (LOX), liquid nitrogen (LIN), and liquid argon (LAR). It is expected that at an evaporation rate of 0.17%/day, a very small amount of sacrificial cryogenic fluid will be required, which re-liquefies the boil-off gas (~4% of the total weight for 30 day shelf-life). The sacrificial vapor gas may be vented. Additionally, by maintaining containers at lower pressures, a thinner and lighter container can be designed.

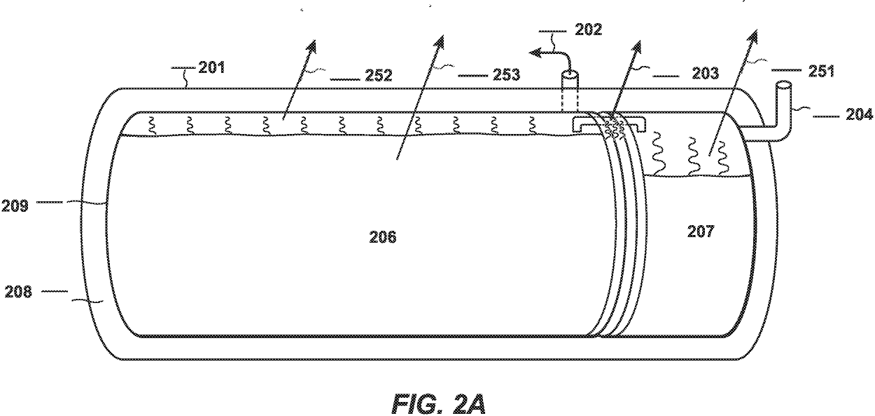

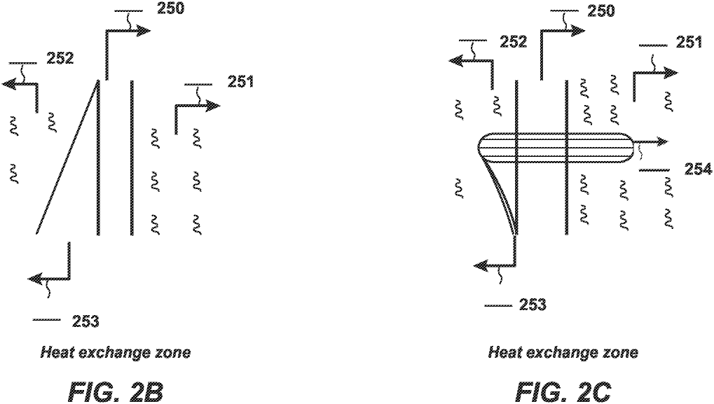

FIG. 2A shows one design of a container system in accordance with one class of embodiments of the invention. The container system includes an outer shell (i.e., outer vessel) 201 and an inner pressurized container (i.e., inner vessel) 209. The inner vessel 209 includes a primary fluid vapor vent 202 and a sacrificial fluid vapor vent 204. Located between the outer vessel 201 and the inner vessel 209 is an interstitial space 208 comprising an at least partial vacuum, which provides an insulating barrier and reduces the heat leakage into the container system from the ambient environment. Contained in the inner vessel 209, there are separate chambers, e.g., tanks, with one chamber 206 for a primary fluid, e.g., LNG and another chamber 207 for a cryogenic sacrificial fluid, e.g., a cryogenic liquid like Liquid Nitrogen (LIN). Additionally, there is at least a region, i.e., a heat exchange zone or device 203, between the two tanks 206 and 207 that is thermally connected and allows for heat exchange between the two tanks. The heat exchange can be between the boil-off vapor 252 of the primary fluid (e.g., LNG vapor) and the boil-off vapor 251 of the sacrificial fluid (e.g., LIN vapor), which results in condensation of the primary fluid (e.g., LNG) vapor 252 back to a liquid 253 (e.g., LNG liquid), while the superheated sacrificial fluid vapor 251 (e.g., LIN vapor) continues further to the sacrificial fluid vapor vent 204 (e.g., a N₂ vent). The reliquefied primary fluid 253 (e.g.,LNG) returns to the storage chamber 206. In the simplest configuration of the heat exchange, as shown in FIG. 2B, the heat exchange zone or device 203 could be a simple wall or barrier 250 that allows for heat transfer, where the wall 250 is cooled by cold sacrificial fluid (e.g., nitrogen) vapor 251 on one side and allows to condense the boil-off gas (BOG) 252 on the other side to form a liquid 253 of the primary fluid.

In another embodiment, an active mechanism, such as a pump, may be used to facilitate heat exchange, where the cryogenic sacrificial fluid (e.g., LIN) is pumped to exchange heat with the BOG and re-liquefy the gas. Finally, in yet another embodiment, a passive device 254, such as a heat pipe, can enable the necessary heat transfer between the cryogenic sacrificial fluid (e.g., LIN/cold nitrogen vapor) 251 on one side of the wall or barrier 250 and the BOG 252 on the other side to form a liquid 253 of the primary fluid, as shown in FIG. 2C.

In an alternative embodiment, the cryogenic sacrificial fluid (e.g., LIN) tank may be disposed directly on top of the primary fluid (e.g., LNG) tank or completely surrounding the primary fluid (e.g., LNG) tank. Without being bound to theory, these options may present a risk of freezing in the primary fluid (e.g.,LNG) but eliminates any risk of over pressure.

The ratio of the length of the outer shell to the length of the inner pressurized container is up to 0.99 and the ratio of the diameter of the outer shell to the diameter of the inner pressurized container is up to 0.99. In the alternative, the ratio of the length of the outer shell to the length of the inner pressurized container is up to 0.95 and the ratio of the diameter of the outer shell to the diameter of the inner pressurized container is up to 0.95. In yet another alternative, the ratio of the length of the outer shell to the length of the inner pressurized container is at least 0.80 and the ratio of the diameter of the outer shell to the diameter of the inner pressurized container is at least 0.80.

The volume percent of the first chamber is from 60 vol% to 90 vol% and the volume percent of the at least one other chamber is from 40 vol% to 10 vol%, based upon the total volume of the inner pressurized container. In the alternative, the volume percent of the first chamber is from 70 vol% to 95 vol% and the volume percent of the at least one other chamber is from 30 vol% to 5 vol%, based upon the total volume of the inner pressurized container. In yet another alternative, the volume percent of the first chamber is from 80 vol% to 97 vol% and the volume percent of the at least one other chamber is from 20 vol% to 3 vol%, based upon the total volume of the inner pressurized container.

The inner pressurized container may comprise at least one wall having a thickness and the thickness of the wall may be 3% thinner than a wall of a container of substantially the same capacity having only one chamber. In the alternative, the inner pressurized container may comprise at least one wall having a thickness and the thickness of the wall may be 5% thinner than a wall of a container of substantially the same capacity having only one chamber. In yet another alternative, the inner pressurized container may comprise at least one wall having a thickness and the thickness of the wall may be 10 % thinner than a wall of a container of substantially the same capacity having only one chamber.

In any of the embodiments described herein, the first chamber of the inner pressurized container may be filled to > 89 vol% with LNG for up to 10 days of storage and/or transportation, without cargo removal, to > 80 vol% with LNG for up to 20 days of storage and/or transportation, without cargo removal, or to > 79 vol% with LNG for up to 30 days of storage and/or transportation, without cargo removal.

In any of the embodiments described herein, the first chamber and the at least one other chamber may comprise different liquefied gases. For example, the first chamber may comprises LNG and at least one other chamber may comprise one or more of nitrogen, argon, or oxygen in a substantially liquid form.

In any of the embodiments described herein, the inner pressurized container may have a boil-off rate of < 0.20% of LNG per day, a boil-off rate of < 0.10% of LNG per day, or a boil-off rate of < 0.05% of LNG per day.

In any of the embodiments described above, the first chamber may be a first tank and the at least one other chamber may be a second tank. In certain embodiments, the first tank may be disposed in the second tank or the first tank may be disposed below the second tank.

In another class of embodiments, the invention provides for a method for transporting and/or storing Liquefied Natural Gas (LNG) comprising:
a) filling the container system with a primary fluid and a sacrificial fluid as described herein;
b) sealing the container system;
c) venting off a sacrificial gas to maintain a desired pressure of the inner pressurized container; and
d) transporting and/or storing the LNG for at least 5 days without refilling the container system;
wherein the inner pressurized container has a boil-off rate of < 0.20% of LNG per day. The first chamber may comprises LNG and the at least one other chamber may comprises at least one of nitrogen, oxygen, or argon in a substantially liquid form.

In these embodiments, the first chamber of the inner pressurized container may be filled to > 89 vol% with LNG for up to 10 days of storage and/or transportation, without cargo removal or to > 80 vol% with LNG for up to 20 days of storage and/or transportation, without cargo removal.

### Liners

The container systems may comprise one or more liners. The liners may have relatively thin walls and typically do not have any load-bearing capability. The liners are constructed from substantially impermeable materials preferably having one or more of the following properties: toughness at cryogenic temperatures, tear resistance, low gas permeation rates, and mechanical integrity.

Substantially impermeable materials that may be utilized in constructing liners include, for example, at least one sheet of: a metallic foil, a synthetic polymer film, a metallic foil on a thin polymeric sheet or substrate, a metal-coated polymer substrate, or a laminate comprising a metallic liner sandwiched between polymeric layers. Suitable metallic foils include, for example, aluminum and stainless steel, preferably seamless. The primary purpose of the liner is to serve as a permeation barrier to the LNG cargo; and the liner need only have sufficient thickness to serve this purpose. Additionally, the liner should be sufficiently strong so that it can be handled without being torn.

In another embodiment, the liner may comprise at least one layer of a coating, for example, a substantially solid polyurethane formulation coating, applied to the inner wall. Such substantially solid polyurethane formulation coatings are commercially available and are currently applied as moisture barriers on the exterior of steel or composite tanks.

### Alternative Geometries for Containers

Containers typically have a standard cylindrical configuration but other shapes are suitable. Alternative geometric shapes for a container include a standard spherical shape, an oblate spheroid with varying aspect ratios; as well as the combinations of oblate spheroidal half domes attached to a relatively short cylindrical section. The flexibility of modem manufacturing processes allow for container configurations to be optimized for structural performance. For example, the spherical configuration for a steel container tends to optimize steel material usage; and, similarly, the oblate spheroid configuration tends to optimize composite material usage.

### Insulated Containers

Containers may be insulated if desired. Several classes of compounds may be used as insulation. A group of foam materials such as polypropylene and polyethylene that meet strain and temperature and thermal conductivity requirements may be used in containers as insulation. Some conventional foams, such as polyurethane, may be used in a substantially noncompact form, for example, honeycomb core form sandwiched between layers of polyisocyanurate to provide an optimal-performing insulation laminate. Sprayable forms of polyisocyanurate and polyurethane may also be used for ease of application as well as moldable forms of polyurethane insulations.

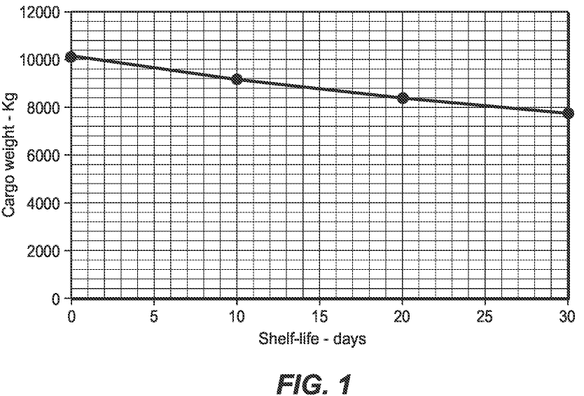

As shown in FIG. 1, while only 3.4% of the LNG evaporates over a 30 day period, the volume occupied by the vapor requires the tank cargo to be reduced by more than 20%. At many places, these ISO containers are used for both storage and transportation, and longer shelf-life is critical to their adoption (e.g. islands such PNG, back-up power applications, etc.). But longer shelf-life results in decreased load per container, resulting in increased cost (move less LNG per batch and require a thicker tank). Therefore, a long-life ISO container offers many benefits.

Glossary of terms:
chamber: an enclosed place or cavity;
container system: a system including a portable receptacle in which freight is placed for convenience of storage and/or transportation and any related equipment or other design features necessary to facilitate the storage or transportation, for convenience, “container system” may be used interchangeably with “container”;
cryogenic temperature: any temperature lower than about -40° C. (-40° F.);
heat exchange zone: an area, optionally, with systems and/or devices, for example, at least one pipe, at least one pump, and/or at least one wall or barrier, used to transfer heat between two or more materials, typically fluids. Heat exchange zones or heat exchangers are used in both cooling and heating processes and may be passive or active.
LNG: liquefied natural gas;
natural gas: a gaseous mixture of hydrocarbons, originally generated below the surface of the earth, which comprises primarily methane and may also comprise ethane, propane, butane, higher hydrocarbons, and/or impurities, including without limiting this invention, nitrogen, carbon dioxide, hydrogen sulfide, helium, etc.;
PLNG: pressurized liquefied natural gas;
psi: pounds per square inch;
psia: pounds per square inch absolute;
sacrificial: designed or intended to be used up or vented/evaporated such as a liquid or gas whose purpose is to serve as a heat sink for the heat leaking into the container and evaporate preferentially to minimize loss of a primary liquid; for example, LNG may be the primary liquid which is being stored and transported while LIN is the sacrificial liquid to be vented as gas; and
substantially: being largely but not necessarily wholly that which is specified, when used with reference to a quantity or amount of a material, or a specific characteristic thereof, refers to the quantity or amount that is sufficient to provide an effect that the material or characteristic was intended to provide, the exact degree of deviation allowable may in some cases depend on the specific context.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the invention, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present invention. Further, all documents and references cited herein, including testing procedures, publications, patents, journal articles, etc. are herein fully incorporated by reference for all jurisdictions in which such incorporation is permitted and to the extent such disclosure is consistent with the description of the present invention.

While the invention has been described with respect to a number of embodiments and examples, those skilled in the art, having benefit of this disclosure, will appreciate that other embodiments can be devised which do not depart from the scope and spirit of the invention as disclosed herein.

What is claimed is:

1. A container system for the transportation and/or storage of Liquefied Natural Gas (LNG), the container system comprising:
a) an outer shell;
b) an inner pressurized container, wherein the inner pressurized container comprises a first chamber having a first vent and at least one other chamber having a second vent;
c) at least one heat exchange zone in thermal communication between the first chamber and the at least one other chamber; and
d) an interstitial space between the outer shell and the inner pressurized container comprising at least a partial vacuum.

2. The container system of claim 1, wherein the ratio of the length of the outer shell to the length of the inner pressurized container is up to 0.99 and the ratio of the diameter of the outer shell to the diameter of the inner pressurized container is up to 0.99.

3. The container system of claim 1, wherein the ratio of the length of the outer shell to the length of the inner pressurized container is at least 0.80 and the ratio of the diameter of the outer shell to the diameter of the inner pressurized container is at least 0.80.

4. The container system of claim 1, wherein the volume percent of the first chamber is from 60 vol% to 90 vol% and the volume percent of the at least one other chamber is from 40 vol% to 10 vol%, based upon the total volume of the inner pressurized container.

5. The container system of claim 1, wherein the volume percent of the first chamber is from 70 vol% to 95 vol% and the volume percent of the at least one other chamber is from 30 vol% to 5 vol%, based upon the total volume of the inner pressurized container.

6. The container system of claim 1, wherein the volume percent of the first chamber is from 80 vol% to 97 vol% and the volume percent of the at least one other chamber is from 20 vol% to 3 vol%, based upon the total volume of the inner pressurized container.

7. The container system of claim 1, wherein the inner pressurized container comprises at least one wall having a thickness and the thickness of the wall is at least 3% thinner than a wall of a container of substantially the same capacity having only one chamber.

8. The container system of claim 1, wherein the inner pressurized container comprises at least one wall having a thickness and the thickness of the wall is at least 5% thinner than a wall of a container of substantially the same capacity having only one chamber.

9. The container system of claim 1, wherein the inner pressurized container comprises at least one wall having a thickness and the thickness of the wall is at least 10% thinner than a wall of a container of substantially the same capacity having only one chamber.

10. The container system of claim 1, wherein the first chamber of the inner pressurized container is filled to > 89 vol% with LNG for up to 10 days of storage and/or transportation, without cargo removal.

11. The container system of claim 1, wherein the first chamber of the inner pressurized container is filled to > 80 vol% with LNG for up to 20 days of storage and/or transportation, without cargo removal.

12. The container system of claim 1, wherein the first chamber of the inner pressurized container is filled to > 79 vol% with LNG for up to 30 days of storage and/or transportation, without cargo removal.

13. The container system of claim 1, wherein the first chamber and the at least one other chamber comprise different liquefied gases.

14. The container system of claim 1, wherein the first chamber comprises LNG.

15. The container system of claim 1, wherein the at least one other chamber comprises one or more of nitrogen, argon, or oxygen in a substantially liquid form.

16. The container system of claim 1, wherein the inner pressurized container has a boil-off rate of < 0.20% of LNG per day.

17. The container system of claim 1, wherein the inner pressurized container has a boil-off rate of < 0.10% of LNG per day.

18. The container system of claim 1, wherein the inner pressurized container has a boil-off rate of < 0.05% of LNG per day.

19. The container system of claim 1, wherein the first chamber is a first tank and the at least one other chamber is a second tank.

20. The container system of claim 19, wherein the first tank is disposed in the second tank or the first tank is disposed below the second tank.

21. The container system of claim 1, wherein the at least one heat exchange zone comprises at least one pump.

22. The container system of claim 1, wherein the at least one heat exchange zone comprises at least one heat pipe.

23. A method for transporting and/or storing Liquefied Natural Gas (LNG) comprising:
a) filling the container system of claim 1 with a primary fluid and a sacrificial cryogenic fluid;
b) sealing the container system;
c) venting off a sacrificial gas to maintain a desired pressure of the inner pressurized container; and
d) transporting and/or storing the LNG for at least 5 days without refilling the container system;
wherein the inner pressurized container has a boil-off rate of < 0.20% of LNG per day.

24. The method of claim 23, wherein the first chamber comprises LNG and the at least one other chamber comprises at least one of nitrogen, oxygen, or argon in a substantially liquid form.

25. The method of claim 23, wherein the first chamber of the inner pressurized container is filled to > 89 vol% with LNG for up to 10 days of storage and/or transportation, without cargo removal.

26. (canceled)
